(19) United States
(12) Patent Application Publication
(10) Pub. No.: US 2024/0289884 A1
(43) Pub. Date: Aug. 29, 2024

(54) METHODS AND APPARATUS FOR QUOTA PLANNING OPTIMIZATION

(71) Applicant: Dell Products L.P., Round Rock, TX (US)

(72) Inventors: Daoyuan Zhang, Needham, MA (US); Luigi Salvatori, Melrose, MA (US); Joseph Matthew Dery, Framingham, MA (US); Zakia Sultana, Lexington, MA (US)

(21) Appl. No.: 18/174,810

(22) Filed: Feb. 27, 2023

(51) Int. Cl. G06Q 40/06

(52) U.S. Cl. CPC G06Q 40/06

(57) ABSTRACT

A method, device, and computer readable medium for allocating a quota deficiency that includes obtaining (i) a goal of an organization, (ii) representative information for a plurality of representatives of the organization, and (iii) account information for a plurality of accounts of the organization. A final quota for each representative of the plurality of representatives is determined using a model of the representative information as well as the account information that is based on the minimization of a quadratic function.

### BACKGROUND

Quota planning is a process of allocating a time-based financial plan to a population of sales representatives in the form of quota targets. Accurate quota planning is critical to meet an organization's financial goals. Further, accurate quota planning may help to drive prescribed sales behavior. While models exist to estimate the quota for sales representatives, there is often a gap between aligning the quotas with an organization's overall financial goals.

### SUMMARY

In one aspect, embodiments described herein relate to a method for allocating a quota deficiency that includes obtaining a goal of an organization, representative information for a plurality of representatives of the organization, and account information for a plurality of accounts of the organization. A final quota for each representative of the plurality of representatives is determined using a model of the representative information and account information that is based on the minimization of a quadratic function. The representative information may include a quota prediction for each representative of a plurality of representatives of the organization and a cap for each representative of the plurality of representatives. The account information may include a headroom for each account of a plurality of accounts of the organization, an upper and lower boundary for each account of a plurality of accounts of the organization, and a quota prediction probability for each account of the plurality of accounts of the organization.

In another aspect, embodiments described herein relate to computer readable medium that stores instructions that when executed by a computer causes the computer to obtain a goal of an organization, representative information for a plurality of representatives of the organization, and account information for a plurality of accounts of the organization. A final quota for each representative of the plurality of representatives is determined using a model of the representative information and account information that is based on the minimization of a quadratic function. The representative information may include a quota prediction for each representative of a plurality of representatives of the organization and a cap for each representative of the plurality of representatives. The account information may include a headroom for each account of a plurality of accounts of the organization, an upper and lower boundary for each account of a plurality of accounts of the organization, and a quota prediction probability for each account of the plurality of accounts of the organization.

In another aspect, embodiments described herein relate to computing device that stores instructions, that when executed by a processor, causes the computing device to execute a method for allocating a quota deficiency. The method includes obtaining a goal of an organization, representative information for a plurality of representatives of the organization, and account information for a plurality of accounts of the organization. A final quota for each representative of the plurality of representatives is determined using a model of the representative information and account information that is based on the minimization of a quadratic function. The representative information may include a quota prediction for each representative of a plurality of representatives of the organization and a cap for each representative of the plurality of representatives. The account information may include a headroom for each account of a plurality of accounts of the organization, an upper and lower boundary for each account of a plurality of accounts of the organization, and a quota prediction probability for each account of the plurality of accounts of the organization.

### BRIEF DESCRIPTION OF DRAWINGS

Certain embodiments of the technology will be described with reference to the accompanying drawings. However, the accompanying drawings illustrate only certain aspects or implementations of the technology by way of example and are not meant to limit the scope of the claims.

FIG. 1 shows a diagram of a system in accordance with one or more embodiments of the technology.

FIG. 2 shows flow charts in accordance with one or more embodiments disclosed herein.

FIG. 3 shows a diagram of a computing device in accordance with one or more embodiments of the technology.

### DETAILED DESCRIPTION

Specific embodiments will now be described with reference to the accompanying figures. In the following description, numerous details are set forth as examples of the technology. It will be understood by those skilled in the art that one or more embodiments of the present technology may be practiced without these specific details and that numerous variations or modifications may be possible without departing from the scope of the technology. Certain details known to those of ordinary skill in the art are omitted to avoid obscuring the description.

In the following description of the figures, any component described with regard to a figure, in various embodiments of the technology, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the technology, any description of the components of a figure is to be interpreted as an optional embodiment, which may be implemented in addition to, in conjunction with, or in place of the embodiments described with regard to a corresponding like-named component in any other figure.

One existing approach to manage an organization's financial goals is to proportionally spread the remaining difference between the sum of the individual customer sale's account predictions to that of the organization's goals. In other words, the individual customer sale's account predictions are summed and proportionally spread across the organization's goals. This difference between the predictions and goals is referred to as a “quota deficiency”. While such approaches may be quick to implement, the approaches fail to consider a sales representatives' growth potential, which may lead to overly aggressive quotas for some representatives (leading to under attainment) and an insufficient quota relative to their covered accounts' potential (leading to over attainment). As a result, the distribution of quota attainment may become skewed in both directions, resulting in a misalignment of sales revenue and, possibly, compensation payouts.

Further, a customer sale's account may be associated with a headroom and a probability of the sale's account current quota prediction. The quota prediction, headroom, and probability may be then be analyzed, for example, with a machine learning model. However, such information is likely not properly leveraged when used in a simple proportional spreading. Furthermore, sales representatives and accounts may be interconnected, such as multiple representatives serving a same account. Therefore, simple proportional spreading cannot account for the complex relationships in the organization's environment.

In general, embodiments disclosed herein are directed to a method and device for allocating a quota deficiency in a way that takes advantage of the intelligence gained from both the assigned accounts and an associated sales representative's potential, while meeting appropriate business constraints. Embodiments present a novel approach that accurately represents the quota deficiency allocation in a timely, scalable way. Embodiments disclosed herein may handle any business requirements regarding quota planning for different types of organizations. Embodiments utilize a quadratic programming solution that can be solved quickly and efficiently. Such embodiments may be critical for quota planning given that the time window for quota deployments may sometimes be as short as a week.

Embodiments of the technology use each sales representative's quota to track the predicted amount by a prediction model, such as a machine learning model. Embodiments then use accounts with more upward headroom to take on a larger share of the quota deficiency. In this context, headroom refers to the amount of stretch in an account's buying potential for the given time period. Embodiments further keep maintained predictions for accounts with predictions at high confidence levels. That is, high confidence predictions will remain closest to the original predictions.

In order to accurately model the system, constraints defining the system must be defined. For example, the total quota for all assigned accounts is equal to the organization's financial target for the given time period. Further, each account has a relative ceiling and floor (i.e., range). The relative ceiling and floor may be based on history, account knowledge, one or more additional models, or a combination thereof. Another constraint may be for each sales representative, who may have multiple accounts, to have a growth rate within both a cap and a floor. This constraint may help to avoid recommending a sales quota that is in the extremes of the historical distribution relative to the geography and go-to-market segment. This constraint may also ensure that a sales representative does not take on an aggressive growth target due to a financial plan that exceeds the total, un-optimized potential of the accounts.

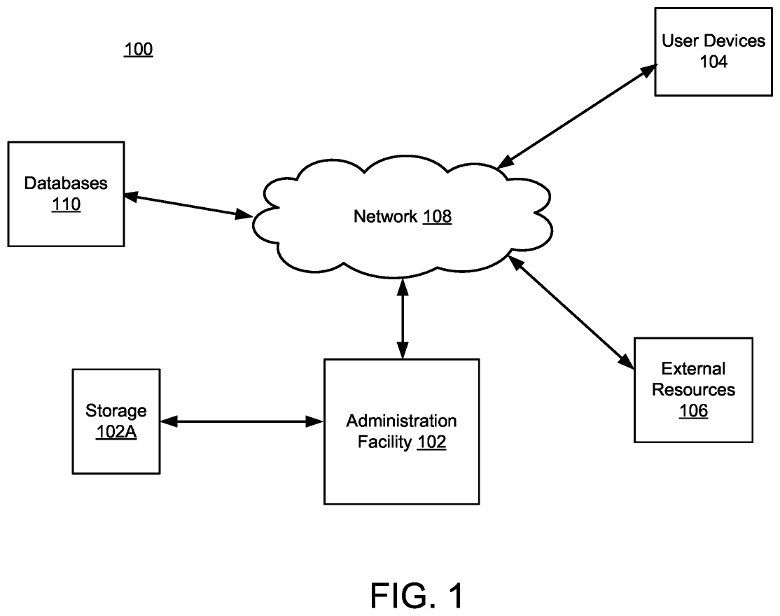

FIG. 1 describes a system in accordance with one or more embodiments of the technology. The system may include an administration facility (102), user devices (104), and external resources (106). In embodiments disclosed herein, the administration facility (102), user devices (104), and external resources (106) may be connected by a network (108). The administration facility (102) may be connected to storage (102A) to store the necessary information to implement embodiments disclosed herein. Some or parts of the necessary information may also be available at one or more external databases (110) that may be accessed through the network (108). Each of these components is described below.

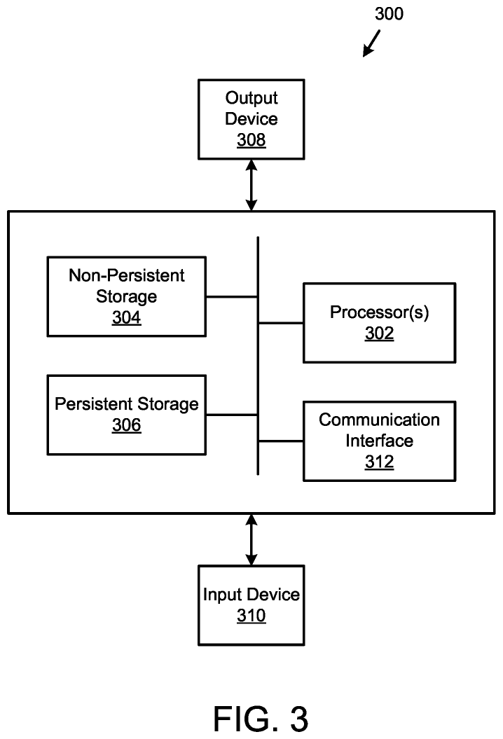

The administration facility (102) may be implemented as one or more computing devices. The computing device may be, for example, embedded computing devices, mobile phones, tablet computers, laptop computers, desktop computers, servers, network devices, or cloud resources. The computing devices may include one or more processors, memory (e.g., random access memory), and persistent storage (e.g., disk drives, solid state drives, etc.). The persistent storage may store computer instructions, e.g., computer code, that (when executed by the processor(s) of the computing device) cause the computing device to perform the functions described in this application. The administration facility (102) may be other types of computing devices without departing from the technology. For additional details regarding computing devices, refer to FIG. 3.

The administration facility (102) may be a logical device without departing from the technology. For example, the user device (104) may be implemented as a virtual machine or other types of logical entities that utilize computing resources of any number of physical computing devices to provide the functionality of the administration facility (102). The administration facility (102) may be another type of logical device without departing from the technology.

The user device (104) may be implemented as a computing device. The computing device may be, for example, embedded computing devices, mobile phones, tablet computers, laptop computers, desktop computers, servers, network devices, or cloud resources. The computing devices may include one or more processors, memory (e.g., random access memory), and persistent storage (e.g., disk drives, solid state drives, etc.). The persistent storage may store computer instructions, e.g., computer code, that (when executed by the processor(s) of the computing device) cause the computing device to perform the functions described in this application. The user device (104) may be other types of computing devices, without departing from the technology. For additional details regarding computing devices, refer to FIG. 3.

The user device (104) may be a logical device without departing from the technology. For example, the user device (104) may be implemented as a virtual machine or other types of logical entities that utilize computing resources of any number of physical computing devices to provide the functionality of the user device (104). The user device (104) may be another type of logical device without departing from the technology.

In this context, the user device (104) may reflect a sales manager's presence in the system (100). A sales representative may be responsible for providing input regarding quotas and the constraints established in accordance with embodiments disclosed herein. If necessary, the user device (104) may provide the means for a sales representative to fine tune model parameters, so that embodiments disclosed herein may more accurately reflect the sales representative's position and goals.

The external resources (106) may be implemented as one or more computing devices. The computing device may be, for example, embedded computing devices, mobile phones, tablet computers, laptop computers, desktop computers, servers, network devices, or cloud resources. The computing devices may include one or more processors, memory (e.g., random access memory), and persistent storage (e.g., disk drives, solid state drives, etc.). The persistent storage may store computer instructions, e.g., computer code, that (when executed by the processor(s) of the computing device) cause the computing device to perform the functions described in this application. The external resources (106) may be other types of computing devices without departing from the technology. For additional details regarding computing devices, refer to FIG. 3.

The external resources (106) may be logical devices without departing from the technology. For example, the external resources (106) may be implemented as a virtual machine or other types of logical entities that utilize computing resources of any number of physical computing devices to provide the functionality of the external resources (106). The external resources (106) may be another type of logical device without departing from the technology.

The external resources (106) may be used to implement one or more steps in embodiments disclosed herein. For example, external resources (106) may be used to process the solvable format described below in accordance with some embodiments disclosed herein. The external resources (106) may also be used to evaluate one or more prediction models that are used in accordance with embodiments disclosed herein.

The storage (102A) and databases (110) represent data storage used to house the data necessary to implement embodiments disclosed herein. The storage (102A) and databases (110) may include memory (e.g., random access memory) and persistent storage (e.g., disk drives, solid state drives, etc.) to store the data.

The network (108) may facilitate communications between the aforementioned devices. The network (108) may utilize any number of operable connections supported by any number and/or combination of wired and/or wireless networks to facilitate communications between the aforementioned devices.

One of ordinary skill in the art will appreciate that embodiments disclosed herein are not limited to the specific system shown in FIG. 1. For example, external resources (106) and databases (110) may not be necessary if the administration facility (102) has the necessary information and resources available.

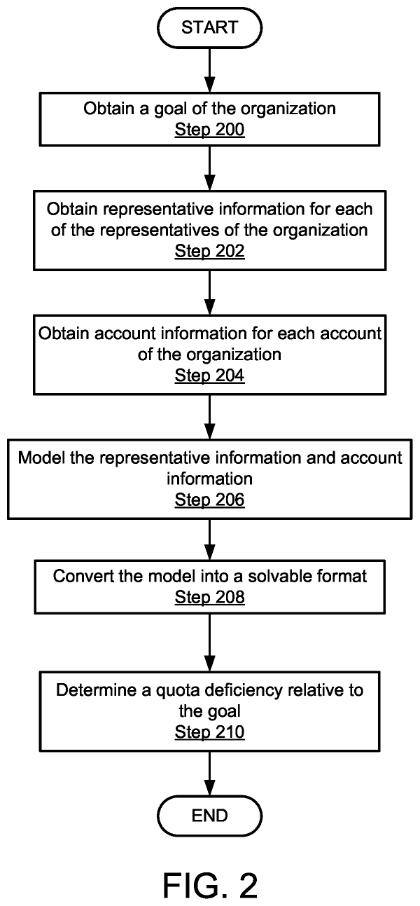

FIG. 2 describes a method in accordance with one or more embodiments of the technology. The method depicted in FIG. 2 may be used to determine a quota deficiency in accordance with one or more embodiments of the technology. The method shown in FIG. 2 may be performed by, for example, the administration facility (102). Other components of the system (e.g., external resources (106)) illustrated in FIG. 1 may perform all, or a portion, of the methods of FIG. 2 without departing from the technology.

In Step 200, a goal of the organization is obtained. The goal of the organization represents the total financial target of the organization for a given time period. In this context, given the total number of accounts (N) to be optimized, each represented by an account index (i), quota predictions for all of the accounts may be determined. The quota deficiency (Q) is the financial target of the organization for a given time period minus the total quota predictions for all the accounts.

In Step 202, representative information for each of the representatives of the organization is obtained. For example, the representative's information includes a cap and floor quota (Cᵢ, cᵢ). The cap and floor quotas (Cᵢ, cᵢ) may be derived from the history of a representative's assigned accounts or from a prediction model based, at least in part, on representative's assigned accounts. The cap and floor quotas (Cᵢ, cᵢ) may also be derived using historical performance metrics of a given representative.

In Step 204, account information for each account in the optimization is obtained. For example, account information includes a headroom (hᵢ), or potential growth, of an assigned account. The headroom (hᵢ) may be derived using a prediction model. The headroom (hᵢ) may also be derived based on combination of the account history and/or local knowledge of an account.

The account information may also include upper and lower bounds (uᵢ, lᵢ) of a given account's potential. The upper and lower bounds (uᵢ, lᵢ) may be derived from the account history and/or using a prediction model. The account information may also include a probability of a prediction (pᵢ). The probability of a prediction (pᵢ) may be derived from a prediction model.

In Step 206, the representative information and account information is modeled. For the model, the difference between an account's final quota and the predicted quota (xᵢ) is used. The sum of the differences (xᵢ) is a representation of the total quota deficiency (Q). The model includes the minimization of an object function (f(x)) of the difference (xᵢ).

Using the variables described above to represent the business elements related to the quota planning, the objective function (f(x)) to be minimized is represented as:

$$f ( x ) = {\sum }_{i = 1}^{N} ( {p}_{i} {x}_{i}^{2} - \frac{{h}_{i}}{{\sum }_{i = 1}^{N} {h}_{i}} {x}_{i} ) \qquad ( 1 )$$

In accordance with the embodiments disclosed herein, the objective function (f(x)) of equation (1) is a quadratic function in the difference between an account's final quota and the predicted quota (xᵢ). This functional form limits the changes (i.e., the delta nature of xᵢ) to be between the final account quota and the originally generated quota prediction. In other words, the variables are centered around an original quota prediction. The prediction probability (pᵢ) is used as the coefficient of xᵢ² to mitigate the delta between the account's final quota and the predicted quota when the probability associated with a given prediction is higher.

In accordance with embodiments disclosed herein, the second term of the objective function, the headroom (hᵢ) is used as the coefficient of xᵢ to allocate larger portions of quota deficiencies with accounts with a larger headrooms.

As part of the model, the objective function (f(x)) is minimized using constraints in accordance with embodiments disclosed herein. For example, the following constraint may be imposed:

$${\sum }_{i = 1}^{N} {x}_{i} = Q \qquad ( 2 )$$

That is, the sum of the difference between an account's final quota and the predicted quota (xᵢ) is the quota deficiency (Q). Recall, the quota deficiency (Q) is the financial target of the organization for a given time period minus the total quota predictions for all of the accounts. The above constraint ensures the organization's financial target for a given time period, Q, is met.

The following is another example of a constraint in accordance with embodiments disclosed herein.

$${l}_{i} \leq {x}_{i} \leq {u}_{i} \qquad ( 3 )$$

Recall, uᵢ and lᵢ are the upper and lower bounds of an account's potential. This constraint ensures that the delta between account's final quota and the predicted quota is within the range of a historical distribution relative to the geography and the go-to-market segment. As noted above, the upper and lower bounds (uᵢ, lᵢ) may be derived based on history, account knowledge, an additional prediction model, or a combination of the aforementioned considerations.

The following is another example of a constraint in accordance with embodiments disclosed herein.

$${c}_{i} \leq {\sum }_{i = 1}^{M} {x}_{i} \leq {C}_{i} \qquad ( 4 )$$

Recall, Cᵢ and cᵢ refer to a sale representative's cap and floor quota, respectively. The cap and floor quotas (Cᵢ, cᵢ) may be derived from the accounts' history of the seller's assigned accounts, in addition to historical performance metrics of said given seller, account knowledge, an additional prediction model, or a combination of the aforementioned. In this constraint, M refers to the number of accounts a representative is assigned in the given time period. One of ordinary skill in the art will appreciate that a sales representative's multiple accounts will be aggregated and bounded using the above constraint.

In other words, with respect to the above constraint, for each sales representative (who will likely have multiple accounts), the sales representative will have a growth rate within both a cap and a floor. By this constraint, recommending a sales quota for a sales representative that is in the extremes of the historical distribution relative to the geography and the go-to-market segment may be avoided. The above constraint will also ensure that each sales representative does not take on an aggressive growth target with a financial plan that far exceeds a potential of the accounts.

Returning to FIG. 2, in Step 208, the model is converted into a solvable format in accordance with embodiments disclosed herein. Solvable formats refer to formats of the aforementioned model that may be processed to solve the minimization problem.

Because the objective function (f(x)) is a quadratic function, but the constraints are linear equalities (i.e., financial target constraint) or inequalities (i.e., growth caps and floors), a unique solution may be obtained. Further, if the constraints are outside of the solution space, it will be apparent that there is “no solution”. For example, if the sum of an account's ceiling bounds is less than the financial target, there is “no solution” because the constraints are outside of the solution. As previously explained, the constraints within the model ensure that sales representatives' quotas remain within reason.

Embodiments of the solvable format and the process for evaluating the model with the constraints are not particularly limited. One of ordinary skill in the art will appreciate the number of methods available for minimizing the quadratic objective function (f(x)) by using the aforementioned constraints. For example, open source software modules for solving quadratic programming problems exist.

The following is one example of a solvable format and process for solving the quadratic objective function (f(x)) with the constraints in accordance with embodiments disclosed herein. For this example, a Python, open-source software module cvxopt is used. Such a module may handle up to 30,000 accounts and 70,000 constraints. For this module, the mathematical model is converted into a condensed matrix format (i.e., the solvable format).

More specifically, the model and constraints may be converted into the following condensed matrix format in accordance with one or more embodiments disclosed herein.

$$f ( x ) = \frac{1}{2} {x}^{T} Px + {q}^{T} x \qquad ( 4 )$$

In this solvable format, the constraints may be represented by Gx≤h and Ax=b. In the above, the number of accounts (x) is a vector with dimension N. This vector has the allocation of the quota deficiency to each account. The constraint Gx≤h represents the caps and ceilings, while the financial target is represented by Ax=b.

Returning to FIG. 2, in Step 210, the solvable format may be processed resulting in a quota deficiency relative to the financial goal. In accordance with one or more embodiments disclosed herein, the solvable format is processed resulting in a solution for x, or the process indicates that there is no solution due to a constraints issue. In the case of a constraints issue, the constraints may be reexamined to identify constraints that may be revised or removed.

Continuing the example, using the above solvable format for a quota block (which covers multiple product lines) with five thousand accounts, the problem may be solved in five minutes with two Graphics Processing Units (GPUs) and 10 GB of memory. As another example, for a quota block with 30,000 accounts, the problem may be solved in 15 minutes with 8 GPUs and 128 GB of memory. Embodiments disclosed herein have demonstrated the ability to process 1 million account potentials that allocates $41 billion of a company quota target across 18,800 sales representative quotas.

Embodiments disclosed herein may apply to any process where there is a target that needs to be allocated across a granular level. For example, quota planning activities and multiple team's budget planning activities. For companies or industries with a financial target to meet with multiple product lines, embodiments may optimally break the target for each product line. Then, for each product line, embodiments may optimally break the sub-target for each sales account.

If an organization has multiple geographical areas and each geographical area has its own sales representatives and financial target, embodiments disclosed herein may be used for each geographical area. In these embodiments, the financial target (Q) would be considered the geographical area's target, and the sales account index (i) would be considered the geographical area's sales representatives.

Further, embodiments disclosed herein may be applied to monthly, quarterly, or any planning duration by using source data with the same duration. For example, for quarterly quota planning, the financial target (Q) will be considered the quarterly target.

As previously mentioned, embodiments of the technology may be implemented using computing devices. FIG. 3 shows a diagram of a computing device in accordance with one or more embodiments of the technology. The computing device (300) may include one or more computer processors (302), non-persistent storage (304) (e.g., volatile memory, such as random access memory (RAM), cache memory), persistent storage (306) (e.g., a hard disk, an optical drive such as a compact disk (CD) drive or digital versatile disk (DVD) drive, a flash memory, etc.), a communication interface (312) (e.g., Bluetooth interface, infrared interface, network interface, optical interface, etc.), input devices (310), output devices (308), and numerous other elements (not shown) and functionalities. Each of these components is described below.

In one embodiment of the technology, the computer processor(s) (302) may be an integrated circuit for processing instructions. For example, the computer processor(s) may be one or more cores or micro-cores of a processor. The computing device (300) may also include one or more input devices (310), such as a touchscreen, keyboard, mouse, microphone, touchpad, electronic pen, or any other type of input device. Further, the communication interface (312) may include an integrated circuit for connecting the computing device (300) to a network (not shown) (e.g., a local area network (LAN), a wide area network (WAN) such as the Internet, mobile network, or any other type of network) and/or to another device, such as another computing device.

In one embodiment of the technology, the computing device (300) may include one or more output devices (308), such as a screen (e.g., a liquid crystal display (LCD), plasma display, touchscreen, cathode ray tube (CRT) monitor, projector, or other display device), printer, external storage, or any other output device. One or more of the output devices may be the same or different from the input device(s). The input and output device(s) may be locally or remotely connected to the computer processor(s) (302), non-persistent storage (304), and persistent storage (306). Many different types of computing devices exist, and the aforementioned input and output device(s) may take other forms.

In a traditional quota planning processes, the predicted individual account quotas often do not sum to the organization's financial target. Simple approaches, such as a proportional allocation, fail to take advantage of the information that may be derived in accordance with embodiments using the prediction model herein. This simple approach also fails to take advantage of an organization's knowledge of each account and each sales representative. Although the proportional allocation strategy may be relatively “quick” to evaluate, a proportional allocation may create scenarios where sales representative attainment distributions are highly skewed, resulting in a disproportionate amount of over and underachievers. As a result, a sales representative achievement is disconnected from the business achievement of the financial plan. The novel quota planning optimization of embodiments disclosed herein overcomes these aforementioned difficulties. Embodiments deliver more accurate quotas by allocating the financial plan based on account and representative data points, while still meeting the organization's financial target.

Embodiments disclosed herein have the advantage of creating an analytical model that precisely reflects all business requirements for quota planning. That is, embodiments reflect meeting an organization's financial target, while considering a ceiling and floor of an account and a representative. Embodiments may be used for any process where there is a target that needs to be allocated across a granular level, for example, quota planning activities for multiple teams' budget planning activities. Embodiments also have the advantage that the model's objectives include tracking the original quota prediction based on the prediction's confidence level to deliver accurate quotas. Embodiments disclosed herein guarantee objective quotas for all in-scope sales representatives by using a consistent analytics model driven by data and probability, without human interaction.

While the technology has been described above with respect to a limited number of embodiments, those skilled in the art, having the benefit of this disclosure, will appreciate that other embodiments can be devised which do not depart from the scope of the technology as disclosed herein. Accordingly, the scope of the technology should be limited only by the attached claims.

What is claimed is:

1. A method comprising:
obtaining a goal of an organization;
obtaining representative information for a plurality of representatives of the organization;
obtaining account information for a plurality of accounts of the organization;
determining a final quota for each representative of the plurality of representatives using a model of the representative information and account information that is based on a minimization of a quadratic function; and
providing each of the final quotas to a corresponding one of the plurality of representatives.

2. The method of claim 1, wherein the representative information comprises:
a quota prediction for each representative of a plurality of representatives of the organization; and
a cap for each representative of the plurality of representatives.

3. The method of claim 1, wherein the account information comprises:
a headroom for each account of a plurality of accounts of the organization;
an upper and lower boundary for each account of a plurality of accounts of the organization; and
a quota prediction probability for each account of the plurality of accounts of the organization.

4. The method of claim 1, further comprising:
receiving updated representative information and account information;
determining a modified final quota for each representative based on the updated representative information and account information.

5. The method of claim 1, wherein the model of the representative information and account information is represented by:
$$f ( x ) = {\sum }_{i = 1}^{N} ( {p}_{i} {x}_{i}^{2} - \frac{{h}_{i}}{{\sum }_{i = 1}^{N} {h}_{i}} {x}_{i} )$$
where xᵢ is a difference between an account's final quota and a predicted quota; hᵢ is a headroom of an assigned account; up, lᵢ is an upper and lower boundary for each account; pᵢ is a quota prediction probability; Cᵢ, cᵢ is a cap for each representative and a floor quota; i is an account index; and N is a total number of accounts to be optimized.

6. The method of claim 5, wherein:
$${c}_{i} \leq {\sum }_{i = 1}^{M} {x}_{i} \leq {C}_{i} ,$$
wherein M is a number of accounts of representative of the plurality of representatives is assigned in a given time period;
lᵢ≤xᵢ≤uᵢ, and
$${\sum }_{i = 1}^{N} {x}_{i} = Q ,$$
wherein Q is an organization's financial target for the given time period.

7. The method of claim 6, wherein the model is converted into:
$$f ( x ) = \frac{1}{2} {x}^{T} Px + {q}^{T} x$$
wherein Gx≤h and Ax=b.

8. A non-transitory computer readable medium (CRM) storing instructions that when executed by a computer causes the computer to execute a method, the method comprising:
obtaining a goal of an organization;
obtaining representative information for a plurality of representatives of the organization;
obtaining account information for a plurality of accounts of the organization;
determining a final quota for each representative of the plurality of representatives using a model of the representative information and account information that is based on a minimization of a quadratic function; and
providing each of the final quotas to a corresponding one of the plurality of representatives.

9. The CRM of claim 8, wherein the representative information comprises:
a quota prediction for each representative of a plurality of representatives of the organization; and
a cap for each representative of the plurality of representatives.

10. The CRM of claim 8, wherein the account information comprises:
a headroom for each account of a plurality of accounts of the organization;
an upper and lower boundary for each account of a plurality of accounts of the organization; and
a quota prediction probability for each account of the plurality of accounts of the organization.

11. The CRM of claim 8, further comprising:
receiving updated representative information and account information;
determining a modified final quota for each representative based on the updated representative information and account information.

12. The CRM of claim 8, wherein the model of the representative information and account information is represented by:
$$f ( x ) = {\sum }_{i = 1}^{N} ( {p}_{i} {x}_{i}^{2} - \frac{{h}_{i}}{{\sum }_{i = 1}^{N} {h}_{i}} {x}_{i} )$$
wherein xᵢ is a difference between an account's final quota and a predicted quota; hᵢ is a headroom of an assigned account; uᵢ, lᵢ is an upper and lower boundary for each account; pᵢ is a quota prediction probability; Cᵢ, cᵢ is a cap for each representative and a floor quota; i is an account index; and N is a total number of accounts to be optimized.

13. The CRM of claim 12, wherein:
$${c}_{i} \leq {\sum }_{i = 1}^{M} {x}_{i} \leq {C}_{i} ,$$
wherein M is a number of accounts of representative of the plurality of representatives is assigned in a given time period;
lᵢ≤xᵢ≤uᵢ, and
$${\sum }_{i = 1}^{N} {x}_{i} = Q ,$$
wherein Q is an organization's financial target for the given time period.

14. The CRM of claim 13, wherein the model is converted into:
$$f ( x ) = \frac{1}{2} {x}^{T} Px + {q}^{T} x$$
wherein Gx≤h and Ax=b.

15. A computing device storing instructions that when executed by a processor causes the computing device to execute a method, the method comprising:
obtaining a goal of an organization;
obtaining representative information for a plurality of representatives of the organization;
obtaining account information for a plurality of accounts of the organization;
determining a final quota for each representative of the plurality of representatives using a model of the representative information and account information that is based on a minimization of a quadratic function; and
providing each of the final quotas to a corresponding one of the plurality of representatives.

16. The computing device of claim 15, wherein the representative information comprises:
a quota prediction for each representative of a plurality of representatives of the organization; and
a cap for each representative of the plurality of representatives.

17. The computing device of claim 15, wherein the account information comprises:
a headroom for each account of a plurality of accounts of the organization;
an upper and lower boundary for each account of a plurality of accounts of the organization; and
a quota prediction probability for each account of the plurality of accounts of the organization.

18. The computing device of claim 15, further comprising:
receiving updated representative information and account information;
determining a modified final quota for each representative based on the updated representative information and account information.

19. The computing device of claim 15, wherein the model of the representative information and account information is represented by as:
$$f ( x ) = {\sum }_{i = 1}^{N} ( {p}_{i} {x}_{i}^{2} - \frac{{h}_{i}}{{\sum }_{i = 1}^{N} {h}_{i}} {x}_{i} )$$
wherein xᵢ is a difference between an account's final quota and a predicted quota; hᵢ is a headroom of an assigned account; uᵢ, lᵢ is an upper and lower boundary for each account; pᵢ is a quota prediction probability; Cᵢ, cᵢ is a cap for each representative and a floor quota; i is an account index; and N is a total number of accounts to be optimized.

20. The computing device of claim 19, wherein:
$${c}_{i} \leq {\sum }_{i = 1}^{M} {x}_{i} \leq {C}_{i} ,$$
wherein M is a number of accounts a representative of the plurality of representatives is assigned in a given time period;
lᵢ≤xᵢ≤uᵢ, and
$${\sum }_{i = 1}^{N} {x}_{i} = Q ,$$
where Q is an organization's financial target for the given time period.
